(19) United States
(12) Patent Application Publication
(10) Pub. No.: US 2005/0179763 A1
(43) Pub. Date: Aug. 18, 2005

(54) Media handling

(76) Inventor: Robert McCarthy, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/782,656

(22) Filed: Feb. 18, 2004

(51) Int. Cl. B41J 13/00; G06K 15/16; B41J 13/10; B65H 29/70; B65H 29/24

(52) U.S. Cl. 347/153; 358/1.12; 271/188; 271/194; 399/388; 399/397

(57) ABSTRACT

An apparatus for handling print media is disclosed. In one example embodiment, the apparatus includes a support and cups mounted on the support, the cups being disposed different distances from the support.

### BACKGROUND OF THE INVENTION

In print media handling systems, problems sometimes arise due to low rigidity of the print media. Thin and lightweight print media tend to have low rigidity. In addition, some print media, such as paper, tends to be less rigid in a direction transverse to a grain orientation of the media. That is, short grain media, or media having a grain orientation parallel with a short dimension of the print media, tends to have low rigidity in the long direction of the media. The long direction of the media is typically the direction of media travel in many applications.

A particular problem is manifest when a row of suction cups is used to hold a sheet of print media. The suction cups often tend to deform the sheet into a cup shape, which may cause the print media to bend in a direction transverse to the direction of media travel if the print media is not sufficiently rigid. This bending tends to cause a leading edge of the print media to curl away from the suction cups, thereby increasing the likelihood that the print media will become detached from the cups, such as by peeling. If the print media does become detached from the cups, a print media jam may occur.

### BRIEF DESCRIPTION OF THE DRAWINGS

FIG. 1 illustrates an imaging device in accordance with an example embodiment.

FIG. 2 illustrates print media handling components of the imaging device of FIG. 1 in accordance with an example embodiment.

FIG. 3 illustrates details of the print media handling components of FIG. 2, in accordance with an example embodiment.

FIG. 4 illustrates the components of FIG. 3 as compressed by a drum, in accordance with an example embodiment.

FIG. 5 illustrates a sheet of print media corrugated by staggered suction cups, in accordance with another embodiment.

### DETAILED DESCRIPTION

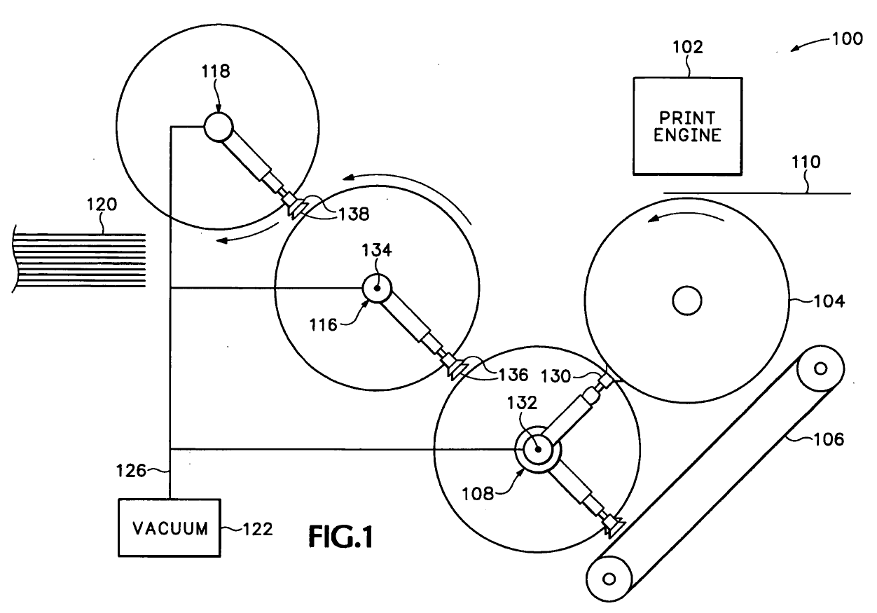

FIG. 1 illustrates an imaging device 100 according to an example embodiment. The imaging device 100 may comprise a liquid electrophotography (LEP) digital press, or other suitable type of imaging device, such as those that employ ink or dry toner as colorants. The imaging device 100 generally includes a print engine 102, a drum 104, a duplex conveyor 106, and a rotating mechanism 108. In some applications, the rotating mechanism 108 may be referred to as a “perfector.” The print engine 102 may comprise an LEP print engine or other suitable print engine.

Rotating mechanisms 116 and 118 may be used to advance print media from the rotating mechanism 108 to an output 120. As shown, a vacuum source 122 provides a source of low pressure or partial vacuum to the rotating mechanisms 108, 116, and 118 to assist in adhering print media thereto. The vacuum source 122 may be co-housed with the rotating mechanisms 108, 116, and 118 or may be housed separately.

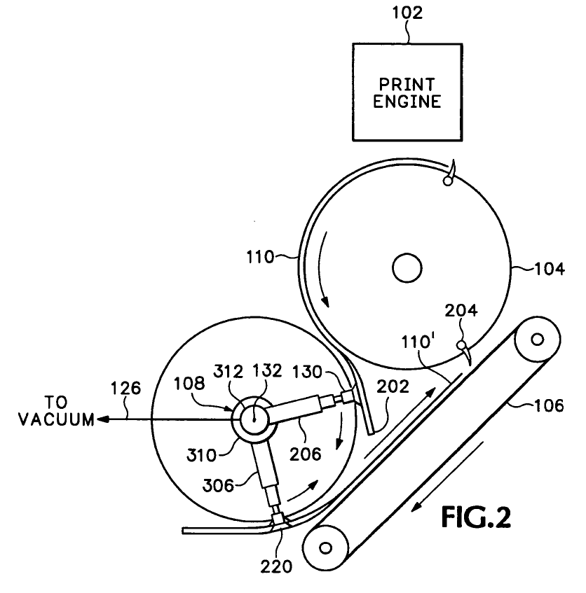

According to an example embodiment, a sheet of print media 110 is advanced onto the drum 104, which rotates. During printing, or imaging, the print media 110 may be maintained on the drum 104 using grippers (FIG. 2) or other suitable techniques. As the print media 110 rotates on the drum 104, the print engine 102 forms an image on the print media. In some embodiments, the print engine 102 prints on a side of the media during several revolutions of the drum 104, although in other embodiments a single revolution may be sufficient. The drum 104 advances the print media 110 to the rotating mechanism 108.

The rotating mechanism 108 includes cups 130 for gripping the print media 110 to pull the print media 110 from the drum 104 and for coupling the print media 110 to the rotating mechanism 108. As discussed below, the cups 130 may comprise suction cups or other suitable members and may be coupled to the vacuum 122 by lines 126 so that the print media 110 is adhered to distal surfaces of the cups by at least a partial vacuum. The cups 130 are staggered relative to each other such that they are not all disposed a same distance from the axis 132 about which the rotating mechanism 108 rotates.

In some embodiments, when the print media 110 is adhered to the staggered cups 130, the print media 110 is bent or corrugated such that the cross-sectional shape of the print media 110 at the cups 130 is non-planar, non-linear (see, e.g., FIGS. 2, 3, 5). By corrugating the print media 110 in the direction of media travel, the rigidity of the print media in the direction of travel is increased, thereby increasing the bending, or beam, strength of the print media in the direction of travel. Typically, the print media 110 will be oriented such that the long axis of the print media is oriented in the direction of travel, although other orientations may be employed in some embodiments.

The imaging device 100 may also provide for duplexing using the duplex conveyor 106, in some embodiments. The duplex conveyor 106 advances print media 110 from the rotating mechanism 108 back to the drum 104. The drum 104 then grips the print media 110 and rotates so that the print media 110 advances to the print engine 102 for printing on the side opposite the initial printing.

After imaging, or printing, of one or both sides of the print media 110 is complete, the rotating mechanism 108 removes the print media 110 from the drum 104 using the cups 130 and advances the print media 110 to the rotating mechanism 116. The rotating member 116 includes cups 136, which grip the print media 110 from the drum 104 and advance the print media to the rotating mechanism 118. The cups 136 of the rotating mechanism 116 may or may not be staggered in a manner similar to the staggering of the cups 130 of the rotating mechanism 108 and are fluidly coupled with the vacuum source 122 for gripping the print media 110 using at least a partial vacuum. In the embodiment shown in FIG. 1, the cups 136 are staggered in that they are disposed different distances from the axis of rotation 134 of the rotating mechanism 116.

The rotating mechanism 118 includes cups 138, which may or may not be staggered, that grip, or adhere to, the print media 110 and advance the print media 110 from the rotating mechanism 116 to the output 120. The cups 138 are also fluidly coupled with the vacuum source 12 for gripping the print media 110 using at least a partial vacuum. In the embodiment shown in FIG. 1, the cups 138 are staggered.

Some embodiments of the present invention may be employed in the printing system described in U.S. Pat. No. 6,438,352, the disclosure of which is hereby incorporated by reference.

FIG. 2 illustrates details of the drum 104 and the rotating mechanism 108. As shown, a sheet of print media 110 is transferred from the drum 104 to the rotating mechanism 108. In effecting this transfer, the rotating mechanism 108 has an angular speed that substantially matches the angular velocity of the drum 104, according to some embodiments. Cups 130, which are shown as being substantially aligned and staggered, adhere to or grip the print media 110 near a leading edge 202 of the print media 110. According to some implementations, the cups 130 grip the print media 110 about 25 mm (millimeters) away from the leading edge 202, measured from the center of the cups 130. Of course, in other embodiments, this distance may vary.

In one embodiment, the cups 130 are compressed by the drum 104 as cups 130 and the drum come into contact and vacuum is raised on the print media 110. The grippers 204 on the drum 104 move to release the print media 110. The cups 130 may be formed of an elastomeric material or other suitable material. Example materials for the cups 130 include rubber and plastic, although other suitable materials may be used.

The cups 130 are mounted on arms 206, which rotate about the axis 132. The arms 206 may serve as supports for the cups 130. In some embodiments, the staggered configuration of the cups 130 is accomplished by the arms 206 having different lengths. The arms 206 may be resilient such that they may be slightly compressed when the cups 130 are tangent with the drum 104. In other embodiments, the cups 130 may be of different heights. Further, in embodiments where cups 130 are mounted on a common structure, some of the cups 130 are mounted on sections of the common structure having different radii.

Cups 220 may optionally be mounted on the rotating mechanism 108 to advance media to the duplex conveyor 106. The cups 220 may or may not be staggered in a manner similar to the staggering of the cups 130. As shown in FIG. 2, the cups 220 are staggered. The cups 220 are coupled to the vacuum source 122 (FIG. 1) and are rotatable independent of the rotation of the cups 130 to advance print media 110′ to the duplex conveyor 106 for return to the drum 104 for duplex printing.

By staggering the cups 130, the print media 110 is corrugated in the area of the print media near the cups 130 and is, thus, more rigid. This added rigidity may be useful in reducing the possibility of the print media 110 becoming prematurely disengaged from the cups 130, such as by peeling off of the cups 130. For example, should the leading edge 202 of the print media 110 contact the print media 110′ moving in a substantially different direction, the contact may tend to cause the print media 110 to become detached from the cups 130. By improving the rigidity of the print media 110 in the direction of media travel, the likelihood of the print media 110 of becoming detached from the cups 130, such as by peeling, is reduced.

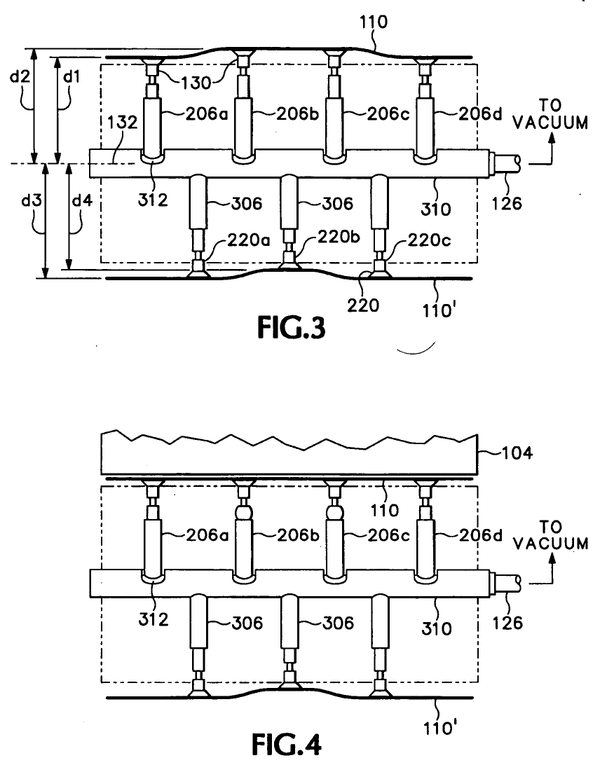

FIG. 3 illustrates details of the rotating mechanism 108. As shown, the cups 130 are mounted on distal ends of arms 206a, 206b, 206c, 206d. Inside cavities of the cups are in fluid communication with the vacuum source 122 via conduits 126. In the illustrated embodiment, the arms 206a, 206b, 206c, 206d are not all of the same length, which results in the cups 130 having a staggered configuration. In this configuration, the distal ends of the cups 130 mounted on the arms 206a and 206d are located a distance d1 from the axis 132 while the distal ends of the cups 130 mounted on the arms 206c and 206d are located a distance d2 from the axis 132. In FIG. 3, the d1 is a smaller distance than d2. In some embodiments, the difference between d1 and d2 may be in the range of about 0.4-2 mm, although this distance may vary. In a particular embodiment, the difference may be about 0.8 mm. In still other embodiments, the difference is greater than about 0.3 mm. The distance between d1 and d2 may be greater than 2 mm in some applications.

In other embodiments (not shown) d1 may be larger than d2. Pursuant to yet additional embodiments, distal ends of arms 206a and 206c may be at a same distance from the axis 132 and the distal ends of 206b and 206d may be at distance from the axis 132 that differs from that of the distal ends of 206a and 206c. Still further embodiments may include at least three cups each having a different distance from the axis 132.

Distal ends of the cups 130 mounted on arms 206b and 206c lie in a first plane that passes through a line having distance d2 from axis 132. Distal ends of the cups 130 mounted on arms 206a and 206d lie in a second plane that passes through a line having distance d1 from the axis 132. In some embodiments, these first and second planes are parallel to each other and are offset by a distance of about 0.3 mm or more. In other embodiments, these first and second planes are parallel to each other and are offset by a distance in the range of about 0.4-2 mm. The distance between d1 and d2 may, of course, vary.

The rotating mechanism 108 may also include cups 220 mounted on arms 306 that rotate separately from the cups 130. The cups 220 in FIG. 3 are shown as being staggered with cups 220a and 220c having distal ends disposed distance d3 from the axis 132 and with cup 220b having a distal end disposed distance d4 from the axis 132. The distance d3 is shown as being greater than the distance d4. In other embodiments (not shown), the distance d3 may be smaller than the distance d4. While the magnitude of the difference between d3 and d4 may vary, in some embodiments this distance is the same or comparable to the distance between d1 and d2 described above.

The arms 206 and 306 are illustrated as being respectively mounted on concentric shafts 310 and 312, respectively. The shafts 310, 312 are configured to rotate separately and independently of each other. A servo mechanism (not shown) or other suitable mechanism may be used to drive the shafts 310, 312. Such mechanisms may employ, for example, one or more of motors, gears, belts, or the like.

FIG. 3 also illustrates the corrugated shape of the print media 110, 110′. As shown, the print media 110 is shown as being corrugated in the direction of media travel with the regions of the media above the arms 206b, 206c being a greater distance from the axis 132 than the regions above the arms 206a, 206d. This corrugated shape of the print media 110 results in the print media having a greater rigidity in the direction of media travel. In FIG. 3, the direction of media travel may be viewed as either into or out of the page. Similarly, the print media 110′ is also shown as being corrugated in the direction of media travel with the regions adjacent the cups 220a and 220c being farther from the axis 132 than the region adjacent the cup 220b.

In some implementations having a more rigid print media tends to reduce the likelihood that the print media will separate, such as by peeling, from the cups, which comprise coupling members to temporarily couple the media to the associated rotating mechanism.

FIG. 4 illustrates the rotating mechanism of FIG. 3 with the cups 130 being compressed by the force of the drum 104. As shown, the drum 104 compresses the cups 130 such that distal surfaces of the cups 130 substantially conform to the shape of the drum 104.

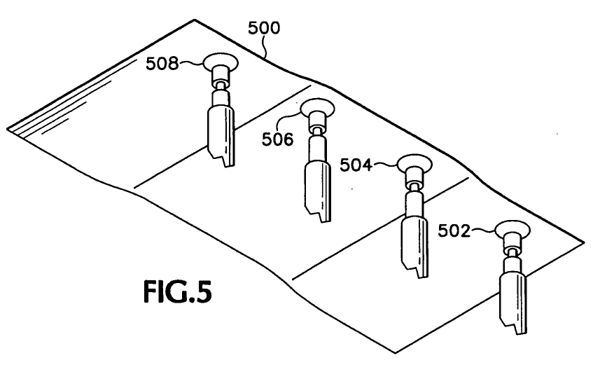

FIG. 5 illustrates a print medium 500 corrugated by cups 502, 504, 506, and 508, which are arranged in a line. The cups 504 and 506 are shown as extending further than the cups 502 and 508. As such, the print medium 500 has a cross-section at the cups that is curved, or corrugated, and, thus results in a greater rigidity of the print medium 500 in a direction orthogonal to the line along which the cups 502-508 are aligned than would exist absent such staggering.

While the present invention has been particularly shown and described with reference to the foregoing example embodiments, those skilled in the art will understand that many variations may be made therein without departing from the spirit and scope of the invention as defined in the following claims. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

1. An apparatus for handling print media, the apparatus comprising:
a support;
at least three cups mounted on the support, each of the three cups having a distal surface for contacting the print media;
the distal surfaces of two of the three cups lying in a first plane and the distal surface of the other of the three suction cups lying in a second plane, wherein the first and second planes are offset from each other.

2. The apparatus of claim 1, wherein the support further comprises a rotatable member.

3. The apparatus of claim 1, wherein the first and second planes are offset from one another by at least 0.3 mm.

4. The apparatus of claim 1, wherein the support is configured to rotate about an axis, at least two of the cups being disposed different distances from the axis.

5. The apparatus of claim 1, further comprising:
a print engine;
a drum for advancing the print media from the print engine to the cups.

6. The apparatus of claim 1, wherein four cups are mounted on the support and are arranged in a line with middle cups being in the first plane and outer cups being in the second plane.

7. An assembly for handling sheet material, the assembly comprising:
a rotor having an axis of rotation;
coupling members mounted on the rotor for adhering sheet material to the coupling members by suction;
wherein at least one of the coupling members is disposed a first distance from the axis of rotation and another of the coupling members is disposed a second distance from the axis of rotation, the first and second distances being different.

8. The assembly of claim 7, wherein the coupling members comprise at least three coupling members arranged in a line.

9. The assembly of claim 7, wherein the coupling members comprise suction cups coupled to a vacuum source.

10. The assembly of claim 7, wherein the coupling members comprise first and second sets of coupling members configured to rotate independently.

11. The assembly of claim 7, wherein the first and second distances differ by at least 0.3 mm.

12. The assembly of claim 7, further comprising a drum positioned adjacent the cups for delivering sheet material to the cups, the drum having a gripper disposed thereon for selectively maintaining the sheet material on the drum

13. An imaging device comprising:
a print engine for forming an image on the medium;
suction members arranged in a line, each suction member configured to rotate about an axis of rotation and to adhere to the medium after the imaging engine has formed an image on the medium;
the suction members being disposed different distances from the axis of rotation and configured to corrugate at least a section of the medium when the medium is adhered to the suction members.

14. The imaging device of claim 13, wherein the suction members comprise at least three suction members with a middle one of the suction members being disposed a first distance from the axis of rotation and other ones of the suction members being disposed a second distance from the axis of rotation, the first and second distances being different.

15. The imaging device of claim 13, wherein the suction members comprise at least four suction members with middle ones of the suction members being disposed a first distance from the axis of rotation and other ones of the suction members being disposed a second distance from the axis of rotation, the first and second distances being different.

16. The imaging device according to claim 13, wherein the imaging engine comprises a liquid electrophotography print engine.

17. A digital imaging press, comprising:
a liquid electrophotography print engine;
a drum for advancing media relative to the print engine;
suction cups configured to rotate about an axis of rotation for adhering to and picking the media from the drum, at least one of the suction cups being disposed farther from the axis of rotation than at least one of the other suction cups such that the media is at least partially corrugated in a direction transverse to a direction of travel at the suction cups.

18. The digital imaging press of claim 17, wherein the suction cups comprise first and second sets of suction cups, the first set of suction cups being rotatable independently from the second set of suction cups.

19. A method for handling print media, the method comprising:
gripping a sheet of print media at different locations of the print media, the different locations being disposed along a line orthogonal to a direction of movement of the print media such that the sheet of print media has a corrugated cross-section along the line orthogonal to a direction of movement;
rotating the print media about an axis, at least two of the different locations being different distances from the axis.

20. A system for handling print media, the system comprising:
means for gripping a sheet of print media at different locations of the print media, the different locations being disposed along a line orthogonal to a direction of movement of the print media such that the sheet of print media has a corrugated cross-section along the line orthogonal to a direction of movement;
means for rotating the print media about an axis such that at least two of the different locations are different distances from the axis.

21. An imaging device, comprising:
means for forming an image on a medium;
means for corrugating the medium such that the medium has a corrugated cross-section in a direction transverse to a direction of travel.
